(19) United States
(12) Patent Application Publication
(10) Pub. No.: US 2015/0255088 A1
(43) Pub. Date: Sep. 10, 2015

(54) METHOD AND SYSTEM FOR ASSESSING KARAOKE USERS

(71) Applicant: Hitlab Inc., Mantréal (CA)

(72) Inventors: Christian Roberge, Candiac (CA); Jocelyn Desbiens, St-Lambert (CA)

(73) Assignee: HITLAB INC., Mantréal, QC (CA)

(21) Appl. No.: 14/430,767

(22) PCT Filed: Sep. 20, 2013
(86) PCT No.: PCT/CA2013/050721

§ 371 Date: Mar. 24, 2015

Related U.S. Application Data
(60) Provisional application No. 61/704,804, filed on Sep. 24, 2012.

(51) Int. Cl. G10L 25/60; G10H 1/36; G10L 25/90

(52) U.S. Cl. CPC G10L 25/60; G10L 25/90; G10H 1/361; G10L 2025/906; G10H 2210/091; G10H 2250/281

(57) ABSTRACT

A karaoke user's performance is recorded, and from the recorded file of the user's rendering of the song, the notes, i.e. the sung melody, is compared with the notes, i.e. the melody, of a reference file of the corresponding song. The comparison is based on an analysis of blocks of samples of sung notes, i.e. of an a cappella voice, and on a detection of the energy envelope of the notes, taking into account pitch and duration of the notes. The results of the comparison give an assessment of the performance of the karaoke in terms of pitch and note duration, as a score.

### FIELD OF THE INVENTION

The present invention relates to karaoke events. More specifically, the present invention is concerned with a method and system for scoring a singing voice.

### SUMMARY OF THE INVENTION

More specifically, in accordance with the present invention, there is provided a method for scoring a singer, comprising defining a reference melody from a reference song, recording a singer's rendering of the reference song, defining a melody of the singer's rendering of the reference song, comparing the melody of the singer's rendering of the reference song with the reference melody; and scoring the singer's rendering of the reference song.

There is further provided a system for scoring a singer, comprising a processing module determining notes duration and pitch of a melody of a reference song and notes duration and pitch of a melody of the singer's rendering of the reference song; and a scoring processing module comparing the notes duration and the pitch of the melody of the reference song and the notes and the pitch of the melody of the singer's rendering of the reference song.

Other objects, advantages and features of the present invention will become more apparent upon reading of the following non-restrictive description of specific embodiments thereof, given by way of example only with reference to the accompanying drawings.

### BRIEF DESCRIPTION OF THE DRAWINGS

In the appended drawings:

FIG. 1 is a diagrammatic view of a a reference processing module according to an embodiment of an aspect of the present invention;

FIG. 2 is a diagrammatic view of a scoring processing module according to an embodiment of an aspect of the present invention;

FIG. 3 illustrates a process by a pitch detector according to an embodiment of an aspect of the present invention;

FIG. 4 illustrates an envelope detection method as used for determining note duration in the case of an audio reference according to an embodiment of an aspect of the present invention; and

FIG. 5 shows an interface according to an embodiment of an aspect of the present invention.

### DESCRIPTION OF EMBODIMENTS OF THE INVENTION

A singing voice, such as a karaoke user's performance, is recorded, and from the recorded file of the user's rendering of the song, the notes, i.e. the sung melody, is compared with the notes, i.e. the melody, of a reference file of the corresponding song. The comparison is based on an analysis of blocks of samples of sung notes, i.e. of an a cappella voice, and on a detection of the energy envelope of the notes, taking into account pitch and duration of the notes. The results of the comparison give an assessment of the performance of the karaoke in terms of pitch and note duration, as a score.

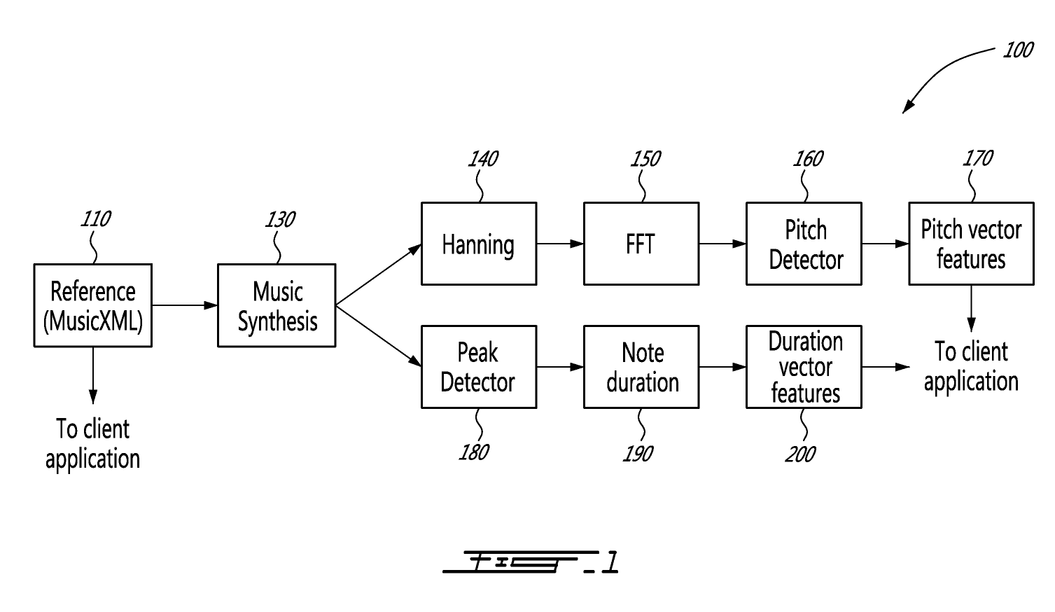

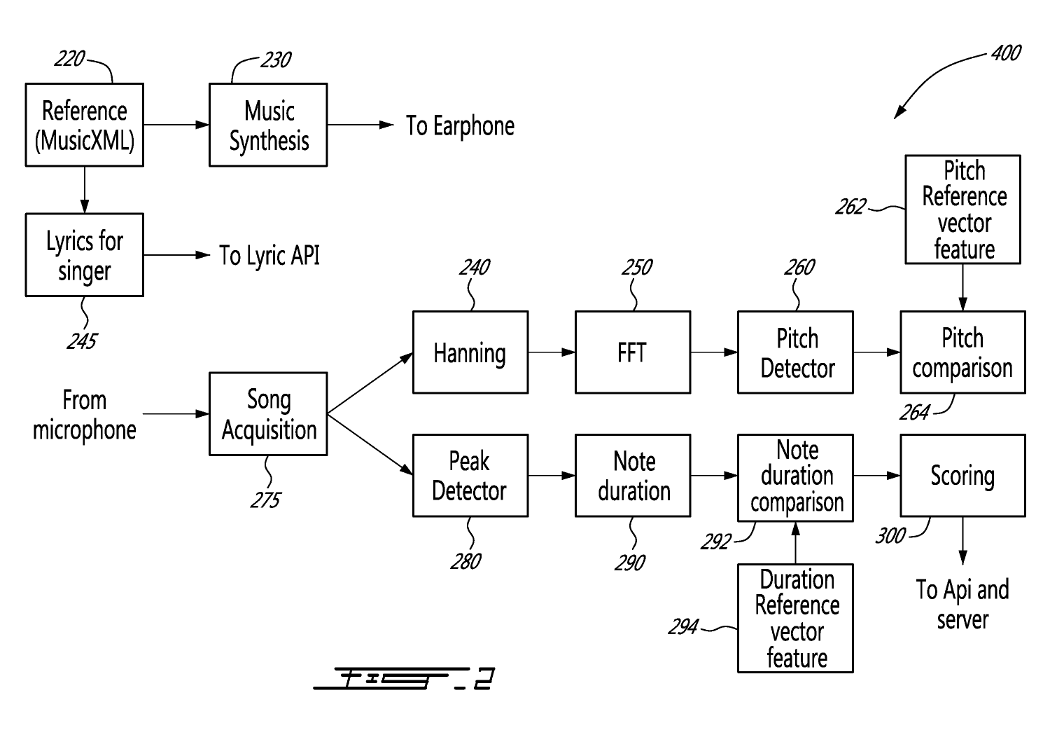

The system generally comprises a reference processing module 100 (see FIG. 1) and a scoring processing module 400 (see FIG. 2).

The reference processing module 100 generates a set R of N parameters, defined as:

R={r₀,r₁,r₂, . . . r_{N}}

The set R defines the melody (notes) of a reference song. It serves as a reference when assessing the quality of the song as sung by a karaoke user.

The scoring processing module 400 determines, from the set R of N reference parameters, a set S of M parameters, corresponding to the quality of the melody as sung by the karaoke user, defined as:

S={s₀, s₁, . . . , s_{M}}

FIG. 1 will first be described.

A number of components are used to define a song, including, for example, the melody (notes) of the song, the background music, and the lyrics. A MusicXML type-file 110 may be used to transfer these components; others may be used, such as MIDI karaoke for example.

The components used to obtain parameters of the reference set R defined hereinabove, are essentially the lyrics and the melody, i.e. the notes to sing, with the duration thereof, the background music being processed so as to single out the voice. This processing comprises building a mono channel by adding the music usually emitted by the left channel and the right channel of a stereo loudspeaker or of an earphone for example and transmitting the mono channel integrally to the left channel of the earphone, and transmitting the mono channel, inverted, on the right channel: the signals of two channels are thus identical save for the phase thereof, which is inverted from the left to the right channels, and the analysis thus proceeds on the mono signal by adding sounds received by the right channel and by the left channel, which theoretically allows cancelling the background music accompanying the voice itself. This pre-processing allows minimizing the sound of the background music at the signal reception. In practice, the minimization is not total, but it is usually sufficient to simplify the analysis in real time, which can thus avoid using recognition algorithms of the voice in a polyphonic signal.

Similarly, the minimization of background music may be performed by restoring a mono channel after the recording of the performance sung (275, FIG. 2). Theoretically, the background sounds are thus canceled. In practice, the minimization is not total, but it is usually sufficient to simplify the analysis in real time. Recognition algorithms for extracting a voice in a polyphonic signal are thus no longer necessary. Ultimately, the non-necessity of these algorithms results in reduced computing power, and provides a complete real-time analysis of the musical performance of the singer.

The reference 110 is received by a music synthesis unit 130, either by a synthetic method or by vocal reference. In the synthetic method, the musical notes of the song are generated from data in the MusicXML file. In the vocal reference method, the voice of a reference singer is recorded, the reference singer singing on a music synthetized from data in the MusicXML file. The music synthesis unit 130 outputs a sampled signal, in which the reference melody is represented by:

X_{A}={x₀, x₁, . . . , xₐ₋₁}

where a is the total number of samples and X_{A} is the set of all samples. This set is divided into blocks defined as:

X={x₀,x₁, . . . , x_{b-1}}

where b is the number of samples in the block X. As a result:

X_{A}={x₀,x₁, . . . , xₐ₋₁}={X₀,X₁, . . . , X_{B}}

where B=a/b is the number of blocks.

While a continuous Fourier transform is achieved in a range [−∞, +∞], a discrete Fourier transform is achieved on a block of N samples, i.e. in a range [0, N−1]. The discrete Fourier transform emulates an infinite number of blocks by repeating the range [0, N−1] infinitely. However, interfering frequencies occur at the borders of the blocks, which may be reduced by applying a weighting window, such as, for example, a Hanning window, which acts on the samples as follows (see 140 in FIG. 1):

$${p}_{n} = 0.5 ( 1 + cos ( \frac{2 π n}{N - 1} ) ) \qquad Pour n = 0 , 1 , … , N - 1$$

$$and$$

$${p}_{n} = 0.5 ( 1 + cos ( \frac{2 π n}{N - 1} ) ) \qquad Pour n = 0 , 1 , … , N - 1$$

where pₙ is the weight of sample n of the block, N is the number of samples in the block, yₙ is the value of the sample n of the block prior to weighing, and xₙ is the value of the weighed sample n of the block.

Considering the samples values x₀, x₁, . . . , xₙ₋₁ from the weighing window (140), a discrete Fourier transform (150) is defined by:

$${f}_{j} = {\sum }_{k = 0}^{n - 1} {x}_{k} {e}^{- \frac{2 π i}{n} j k}$$

$$j = 0 , … , n - 1.$$

Or, in a matrix notation:

$$( \begin{matrix}{f}_{0} \\ {f}_{1} \\ {f}_{2} \\ ⋮ \\ {f}_{n - 1}\end{matrix} ) = ( \begin{matrix}1 & 1 & 1 & … & 1 \\ 1 & w & {w}^{2} & … & {w}^{n - 1} \\ 1 & {w}^{2} & {w}^{4} & … & {w}^{2 ( n - 1 )} \\ ⋮ & ⋮ & ⋮ & ⋱ & ⋮ \\ 1 & {w}^{n - 1} & {w}^{2 ( n - 1 )} & … & {w}^{{( n - 1 )}^{2}}\end{matrix} ) ( \begin{matrix}{x}_{0} \\ {x}_{1} \\ {x}_{2} \\ ⋮ \\ {x}_{n - 1}\end{matrix} ) , w = {e}^{- \frac{2 π i}{n}}$$

The discrete Fourier transform has a fast version which allows a very efficient processing of the above relations by a computer. A fast Fourier transform is based on symmetries that appear in the matrix notation, whatever the value of n.

According to a property of the Fourier transforms, when the values xₖ are real numbers, which happens to be the case here, only the first half of the n coefficients need be processed since the second part relates to the complex conjugate values of the first half.

A pitch detector (160) is used for determining the frequency of the reference note, as follows:

p=max(f_{d}, f_{d+1}, . . . , fᵤ₋₁, fᵤ)

where d is the index of the minimal frequency of the search, u is the index of the maximal frequency of the search, and p is the index corresponding to the maximum of the frequency spectrum.

The optimal values of the frequency range [d, u] ideally correspond to the lowest and the highest frequencies of the song respectively. Whenever these lowest and the highest frequencies of the song are unknown, a frequency range corresponding to the dynamic frequency range of a number of songs may be used.

The comparison between the reference and the song as sung by the karaoke user is performed based on a psycho-auditory basis corresponding to what the human ear perceives. Considering such a basis, a logarithmic scale is used for the frequency representation. However, a logarithmic scale tends to under represent lower frequencies compared to higher frequencies, which greatly reduces the ability to assess the real frequency, i.e. the musical note as sung by the karaoke user. In order to overcome this shortcoming, the following relation is applied:

$${p}_{e} = p + \frac{\frac{{f}_{p - 1} - {f}_{p}}{6} - \frac{{f}_{p - 1}}{2} + \frac{{f}_{p} - {f}_{p + 1}}{6} + \frac{{f}_{p + 1}}{2}}{\frac{{f}_{p} - {f}_{p - 1}}{2} + {f}_{p - 1} + \frac{{f}_{p} - {f}_{p + 1}}{2} + {f}_{p + 1}}$$

where p is the index of the maximum frequency, and pₑ is the index of the estimated maximum.

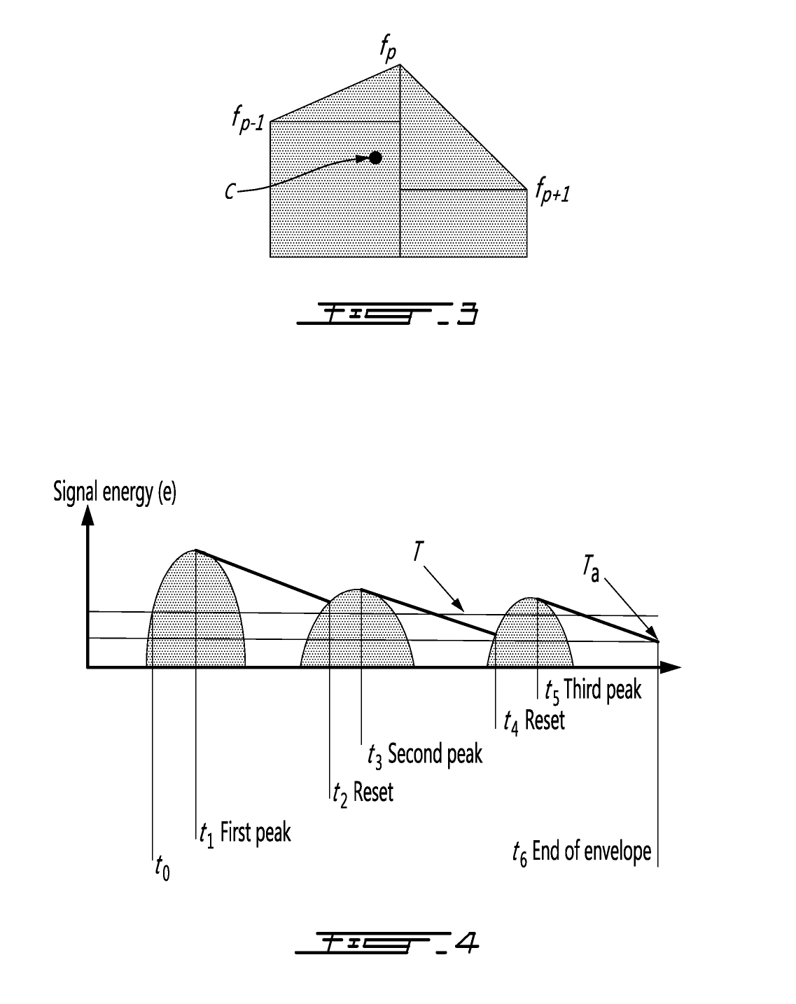

This relation represents the position in frequency index of the center of gravity C of the area defined by FIG. 3. Varignon principle is used to merge the centers of gravity of the 4 four geometric shapes, i.e. two squares and two triangles, of known formulas. The estimated frequency pₑ is transformed into the MIDI space by:

$${m}_{e} = \frac{log ( \frac{{p}_{e} E}{b} )}{log ( \sqrt[12]{2} )} - log ( {M}_{0} )$$

where E is the sampling frequency, b is the number of samples in a block, and M₀=8,17579891564 Hz, i.e. the frequency of the first MIDI note, noted MIDI 0.

Each block provides an estimated index of the position of the maximum. In the case of an audio reference, the spectral energy of the maximum peak is thus stored.

The sampled signal, in which the reference melody is represented, generated by the music synthesis unit 130, is also transmitted to a peak detector 180. Two cases arise, depending on the type of the reference.

For a XLM, KAR or MIDI reference, the peak detection consists of detecting the presence or absence of a note melody: a maximum energy is considered when a note of the melody is present and a null energy is considered in absence of the note.

For an audio reference, detection of a peak corresponds to a sudden energy level in the input signal. The peak detector (180) may work on an analog detection of AM frequency demodulation, adapted as follows:

X_{|A|}={|x₀|, |x₁|, . . . , |xₐ₋₁|}

where |y| is the absolute value of y. Detection is done by a thresholding defined by:

X_{P}={p₀,p₁, . . . , pₐ₋₁}

where pᵢ=|xᵢ|>T pour i=0, 1, . . . , a−1 and T is the minimum threshold for detection of an energy peak.

With respect to note duration, in the case of a XLM, KAR or MIDI reference, the duration of the note, i.e. the length of time the note is sustained, corresponds to a duration indicated in the reference XML or KAR file.

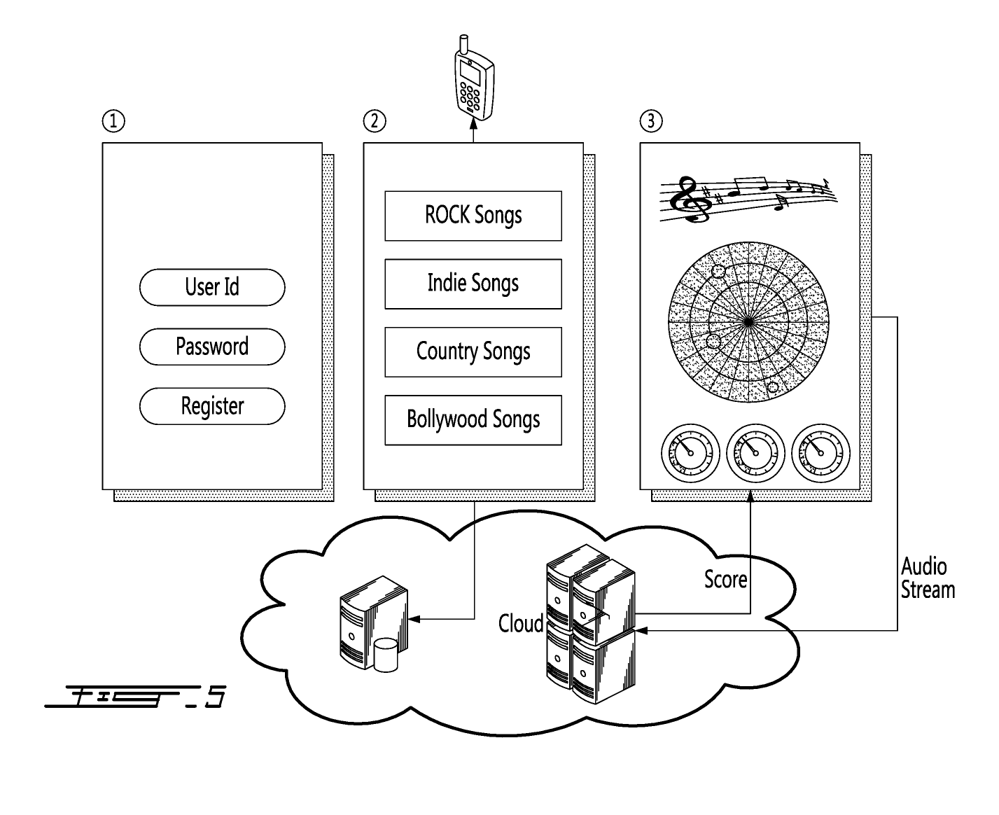

In the case of an audio reference, FIG. 4 illustrates an envelope detection method as used herein for determining note duration (190). First, the signal envelope is determined. This envelope starts at t₀ when the signal energy reaches the threshold T. The energy of the envelope at time i is referred to as eᵢ. For the following sample, at time i+1, either of the following cases may occur: a) if the signal energy is greater than eᵢ, then the value eᵢ₊₁ takes this new value of energy; or b) if the signal energy is lower than eᵢ, then the value eᵢ₊₁ takes the value eᵢ*r, where r is a relaxation factor. The envelope stops when the value eᵢ gets lower than a trip set point Tₐ. The signal envelope is characterised by time t₀ and the duration (from t₀ to t₆).

The duration of a note is estimated using this envelope. In fact, generally, the envelope corresponds to a plurality of notes. The duration estimated using this envelope allows to assess a singer's capacity to sustain notes without getting out of breath, and there is no need to discriminate between notes.

In FIG. 4, a fixed trip set point Tₐ is shown. In practice, the trip set point Tₐ is set at half the value of the energy of the first peak, so as to adapt to amplitude variations of the input signal. Hence, the envelope of a first singer singing louder than a second singer stops at the same point as the envelope of a second singer singing in a lower voice, which allows an equitable scoring between the different users.

Moreover, in FIG. 4, a linear relaxation is shown (in bold). In fact, relaxation is selected to be exponentially decreasing, so as to minimise pulse noises at high energy, voice outbursts and other acquisition noises, which are not representative of the melody of the song.

In (200), a pair vector (t, l) is created for the whole song. Time t is represented as samples where t₀ is the first sample and l is the length in number of samples of the envelope.

The client application receives the set of all envelopes of the reference file, described by vector Eᵣ:

Eᵣ={(t₀,l₀),(t₁,l₁), . . . , (tₘ,lₘ)}

where m is the number of envelopes, i.e. the dimension of the vector.

Thus, the processing module 100 generates a set R of N parameters, defining the melody (notes) of a song, in terms of pitch and duration (i.e. time envelope). It serves as a reference when assessing the quality of the song as sung by a karaoke user.

Turning now to FIG. 2, the client application receives the reference song. A MusicXML type-file 220 may be used, but any other support that allows synchronization of lyrics and music may be used. A music synthesis unit 230 is used to generate the background music the karaoke user will hear, through earphone for example. The background music may originate from an audio synthesis comprised in the MusicXML file or from other support allowing producing it. The lyrics 245 are synchronised with the time at which they need to be sung. They are transmitted to a lyric application program interface Api and synchronised with the time at which they need to be sung by the karaoke user.

The karaoke user, typically wearing earphones for the background music, performs in front of a microphone for the recording of his/her rendering of the song. At the microphone, an “a cappella” performance without musical accompaniment is collected 275, as described hereinabove in relation to FIG. 1. The extraction of the sung notes can thus be performed without having to first single out each note from a set of polyphonic notes in a musical accompaniment. The signal thus captured by the microphone is recorded by a client Api; the digitized signal is transmitted to the processing units (240/280 see FIG. 2) to obtain the karaoke user's file: this signal is processed for determining pitch and note duration , through a Hanning window, (240), a Fourier transform (250), a pitch detector (260) as described hereinabove in relation to the reference song (FIG. 1, see 140, 150, 160). In 260, the frequency analysis also yields the maximum peak mₑ for the karaoke user's signal. However, this value is not always representative of the note as truly sung by the karaoke user. Indeed, a number of physical events may mix up the frequency signal, such as: ambient noise level, a hoarse voice, signal distortion, signal saturation, background noises, etc. . . . Generally, such events tend to overestimate the higher frequency energies. In such cases, mₑ may fail to be representative of the note as truly sung. In order to overcome these problems, the second highest peak is searched for in the block, to obtain a value mₑ₂, identical to mₑ, but excluding frequency samples close to the value p in this second search. The exclusion range around p depends on the first estimate mₑ and is about ±2.5. The exclusion range is expressed herein in MIDI note units for clarity. In practice, p=max(f_{d}, f_{d-1}, . . . , fᵤ₋₁, fᵤ) is used, with a frequency scale and which gives, during the second search:

p₂=max(f_{d},f_{d-1}, . . . , fᵢ,fⱼ, . . . , fᵤ₋₁, fᵤ)

where:

$$i = \frac{b}{E} {log}^{- 1} \{ ( {m}_{e} + log ( {M}_{0} ) - 2.5 ) * log ( \sqrt[12]{2} ) \}$$

$$and$$

$$j = \frac{b}{E} {log}^{- 1} \{ ( {m}_{e} + log ( {M}_{0} ) + 2.5 ) * log ( \sqrt[12]{2} ) \} .$$

log⁻¹ refers to either e^{x} or 10^{x}. The logarithm type is undefined in the above relations. It may be a naperian or a basis 10 logarithm. The above relations are independent from the logarithm type.

Each block provides two estimated indexes of the position of the maximum. The spectral energy of the peaks is then stored, for pitch comparison (262, 264). The characteristics are represented by 6 vectors defined as follows:

V_{R}={mₑ_{_{C}},mₑ_{₁}, . . . , mₑ_{_{b}}}

E_{R}={e₀,e₁, . . . , e_{b}}

V₁={mₑ_{_{1,C}}, mₑ_{_{1,1}}, . . . , mₑ_{_{1,b}}}

E₁={e_{1,0},e_{1,1}, . . . , e_{1,b}}

V₂={mₑ_{_{2,C}},mₑ_{_{2,1}}, . . . , mₑ_{_{2,b}}}

E₂={e_{2,0},e_{2,1}, . . . , e_{2,b}}

where V_{R} is a vector of the values of the reference notes for each black; E_{R} is the frequency energy of the reference note; V₁ is a vector of estimated notes values for each block; E₁ is the frequency energy of the note of the maximum peak; V₂ is a vector of estimated notes (second peak) values for each block; and E₂ is the frequency energy of the note of the second maximum peak.

The comparison between the reference notes and the karaoke user's notes (264) yields the following relation:

$${C}_{i , l} = {min}_{j = - l , … , l} ( \vert {V}_{{R}_{i}} - 12 * j * {V}_{{1}_{i}} \vert , \vert {V}_{{R}_{i}} - 12 * j * {V}_{{2}_{i}} \vert )$$

where i is the block index; j is the harmonic comparison index; and I is the index of the octave of search about the reference note.

The comparison relation takes into account harmonics of musical scales. Modulo 12 corresponds to a same note in a different musical octave. This modulo allows taking into account the register of the karaoke singer. For example, a woman's voice is naturally one octave higher than a man's voice. The function

$${min}_{j = - l , … , l}$$

applies to all values of the set of harmonic comparison indexes. As a result, a single value C_{i,l} is generated. It is to be noted that the computation of comparisons C_{i,l} is performed only if the frequency energy is sufficient, i.e. above s_{c}. If V_{R}_{ᵢ} have null values or the set V₁_{ₗ} and V₂_{ₗ} all have null values, C_{i,l}=0.

Two characteristics are derived from the values C_{i,l}, as follows:

$${D}_{{1}_{i}} = {min}_{j = - 1 , … , 1} ( {C}_{i + j , l} )$$

$${D}_{{5}_{i}} = {min}_{j = - 5 … , 5} ( {C}_{i + j , i} )$$

In cases of KAR or MusicXML references, the tests for the reference energy are useless since the reference is entirely synthetized. The karaoke user does not have any clue about how loud he must use for singing. As a result, the value s_{c} is uncalibrated. In order to overcome this situation, a calibration is performed to adjust the value of the threshold s_{c} as follows: determining the average energy mₚ of the blocks of the karaoke user's file in presence of a note in the reference file; determining the average energy mₐ of the blocks of the karaoke user's file in absence of a note in the reference file; determining the average energy m_{q} of the note of the blocks of the karaoke user's file in presence of a note in the reference file; and determining the average energy m_{b} of the note of the blocks of the karaoke user's file in absence of a note in the reference file. Thresholds are obtained as follows:

$${s}_{c} = {10}^{( \frac{{log}_{10} ( {m}_{p} ) - {log}_{10} ( {m}_{g} )}{2} )}$$

$${s}_{e} = {10}^{( \frac{{log}_{10} ( {m}_{g} ) - {log}_{10} ( {m}_{b} )}{2} )} .$$

In cases of audio signals, the value s_{c} may be manually determined upon launching the program.

As described hereinabove, this signal is also processed, through a peak detector (280) (see 180 for the reference signal, FIG. 1), and note duration (290) (see 190 for the reference signal, FIG. 1). The following vector is obtained:

E_{C}={(t₀,l₀),(t₁,l₁), . . . , (tₙ,lₙ)}

where n is the number of envelopes, i.e. the dimension of the vector.

The note duration is determined as described hereinabove in relation to 190, 200 in FIG. 1, and compared with the reference (294). In 292, three characteristics are extracted for comparison. Comparisons are performed according to two vectors, i.e. the set of all envelopes of the reference file Eᵣ, and the set of all envelopes of the karaoke user's file E_{C}:

Eᵣ={(t₀,l₀),(t₁,l₁), . . . , (tₘ,lₘ)}

and

E_{C}={(tt₀,ll₀),(tt₁,ll₁), . . . , (ttₙ,llₙ)}.

A first characteristic compares the total duration of the envelopes:

$${F}_{1} = \frac{{\sum }_{i = 0}^{m} {l}_{i}}{{\sum }_{j = 0}^{n} {ll}_{j}} if {\sum }_{i = 0}^{m} {l}_{i} < {\sum }_{i = 0}^{n} {ll}_{j} or$$

$${F}_{1} = \frac{{\sum }_{j = 0}^{n} {ll}_{i}}{{\sum }_{i = 0}^{m} {l}_{i}} otherwise .$$

A second characteristic compares envelopes, by determining whether a sample, at time t, is found simultaneously in one envelope of Eᵣ and in one envelope of E_{C}. Such samples are grouped in F′₂. Thus:

$${F}_{2} = \frac{{F}_{2}^{′}}{{\sum }_{i = 0}^{m} {l}_{i}} .$$

A third characteristic compare the energy envelopes by blocks. In this case, the energy of a note in a block is considered, rather than the envelope of the signal. Such procedure allows eliminating background noise that triggers detection of notes and envelopes. The energy of the signal is weak, which allows evidencing false detections. For each bloc, under parameters are determined as follows:

With F′₃ the number of blocks where the energy of the note is above a threshold T_{f} both in the reference and in the client signals, F″₃ the number of blocks where the energy of the note is above the threshold T_{f} only in the reference signal, F′″₃ the number of blocks where the energy of the note is above the threshold T_{f} only in the client signal, the third characteristic is then given by:

$${F}_{3} = \frac{\frac{{F}_{3}^{′} - {F}_{3}^{″} + {F}_{3}^{′″}}{2}}{{F}_{3}^{′} + \frac{{F}_{3}^{″} + {F}_{3}^{′″}}{2}} .$$

Moreover, F₃ will be set to zero when

$$\frac{{F}_{3}^{″} - {F}_{3}^{′″}}{2} > {F}_{3}^{′} or {F}_{3}^{′} + {F}_{3}^{″} + {F}_{3}^{′″} = 0.$$

The final score (300) is given by S=F₃*c₆, where:

$${c}_{6} = min ( \frac{{d}_{1} + {d}_{5}}{2} , 0 ) .$$

d₁ and d₅ are derived from C_{i,1} and C_{i,5} respectively. The values C_{i,l} are obtained to find the minimum error between two notes and use the absolute value in their formulas. d₁ and d₅ are obtained without considering the absolute value of the minimum because the negative values and the positives values are weighted differently in order to take into account psycho-auditory characteristics. Indeed, it has been noted that a note sounds falser when sung lower than higher. Thus d₁ and d₅ are obtained as follows:

$${d}_{i , j} = \{ \begin{matrix}{p}_{d} * {C}_{i , j} & si {C}_{i , j}^{sign} < 0 \\ {C}_{i , j} & autrement\end{matrix} .$$

where C^{sign}_{i,j} is the sign of the minimum of C_{i,j}, and p_{d} is a weighting factor for negative values, here fixed to 2.

Thus:

$${d}_{j} = ( 1 - \frac{{\sum }_{i = 0}^{b - 1} {d}_{i , j}}{b} ) * 100$$

where b is the number of blocks.

The score is sent to an Api and server for example.

FIG. 5 is an interface for using the method of the invention. A user in invited to register by entering a user ID and a password on a smart phone screen for example. He is then given the choice of types of songs, such as between rock songs, indie songs, country songs, Bollywood songs for example, so he can choose the song he wants to perform. The application then runs as the user sings the selected song, recorded by a microphone of the smart phone for example, and outputs a score assessing the user's performance, as described hereinabove.

The present method comprises processing a reference song, as either an “a cappella” voice or a digital file such as MIDI, MusicXML for example, modifying the audio references to the user so as to single out the voice by inverting a mono channel in one of the transmission channels of the accompanying music, detecting the notes one by one, analysing the signals and scoring.

As people in the art will appreciate, the present method and system provide assessing the quality of the reference sung notes and of the notes sung by the user, by using an estimation of the frequency of the sung notes. The comparison includes comparing signals envelopes and pitch. The pitch analysis is simplified since the voice from the background is singled out during recording.

The scope of the claims should not be limited by the embodiments set forth in the examples, but should be given the broadest interpretation consistent with the description as a whole.

1. A method for scoring a singer, comprising:
defining a reference melody from a reference song;
recording a singer's rendering of the reference song;
defining a melody of the singer's rendering of the reference song;
comparing the melody of the singer's rendering of the reference song with the reference melody;
and scoring the singer's rendering of the reference song.

2. The method of claim 1, wherein said defirdng the reference melody comprises cancelling an accompanying music from the reference song.

3. The method of claim 1, wherein said defining the reference melody comprises cancelling an accompanying music from the reference song and building a mono channel and inverting the mono channel in one of two transmission channels of the accompanying music.

4. The method of claim 1, wherein:
said defining the reference melody comprises representing the reference melody as a sampled signal; determining the pitch of notes of the reference melody from a frequency representation of the sampled signal; and determining notes duration in the sampled signal; and
said defining the melody of the singer's rendering of the reference song comprises representing the melody of the singer's rendering as a sampled signal; determining the pitch of notes of the melody of the singer's rendering from a frequency representation of the sampled signal; and determining notes duration in the sampled signal.

5. The method of claim 1, wherein said comparing comprises comparing notes duration and pitch of the reference melody with notes duration and pitch of the melody of the melody of the singer's rendering.

6. The method of claim 1, wherein said comparing comprises comparing notes of the reference melody and notes of the melody of the singer's rendering comprises a frequency analysis of blocks of samples of sung notes, and a detection of energy envelope of the notes.

7. The method of claim 1, wherein said comparing comprises comparing notes of the reference melody and notes of the melody of the singer's rendering comprises a frequency analysis of blocks of samples of sung notes, and a detection of energy envelope of the notes, said method further comprising comparing a total duration of the energy envelopes, envelopes, and energy of the envelopes by blocks.

8. A system for scoring a singer, comprising:
a processing module determining notes duration and pitch of a melody of a reference song and notes duration and pitch of a melody of the singer's rendering of the reference song; and
a scoring module comparing the notes duration and the pitch of the melody of the reference song and the notes and the pitch of the melody of the singer's rendering of the reference song.
